(19) United States
(12) Patent Application Publication
(10) Pub. No.: US 2003/0198395 A1
(43) Pub. Date: Oct. 23, 2003

(54) Wavelet transform system, method and computer program product

(75) Inventors: William C. Lynch, Palo Alto, CA (US); Krasimir D. Kolarov, Menlo Park, CA (US); Steven E. Saunders, Cupertino, CA (US)

Correspondence Address: SILICON VALLEY INTELLECTUAL PROPERTY GROUP, P.O. BOX 721120, SAN JOSE, CA, 95172-1120, US

(73) Assignee: DROPLET TECHNOLOGY, INC.

(21) Appl. No.: 10/418,363

(22) Filed: Apr. 17, 2003

Related U.S. Application Data
(60) Provisional application No. 60/373,974, filed on Apr. 19, 2002.
(60) Provisional application No. 60/373,966, filed on Apr. 19, 2002.
(60) Provisional application No. 60/385,254, filed on May 28, 2002.
(60) Provisional application No. 60/390,383, filed on Jun. 21, 2002.

(51) Int. Cl. G06K 9/36

(52) U.S. Cl. 382/240

(57) ABSTRACT

A system, method and computer program product are provided for compressing data. Initially, an interpolation formula is received. Such interpolation formula is utilized for compressing data. In use, it is determined whether at least one data value is required by the interpolation formula, where the required data value is unavailable. If such is the case, an extrapolation operation is performed to generate the required unavailable data value.

### RELATED APPLICATION(S)

The present application claims priority from a first provisional application filed Apr. 04, 2002 under serial No. 60/373,974, a second provisional application filed Apr. 19, 2002 under serial No. 60/373,966, a third provisional application filed Jun. 21, 2002 under serial No. 60/390,383, and a fourth provisional application filed May 28, 2002 under serial No. 60/385,254, which are each incorporated herein by reference in their entirety.

### FIELD OF THE INVENTION

The present invention relates to data compression, and more particularly to compressing data utilizing wavelets.

### BACKGROUND OF THE INVENTION

Video “codecs” (compressor/decompressor) are used to reduce the data rate required for data communication streams by balancing between image quality, processor requirements (i.e. cost/power consumption), and compression ratio (i.e. resulting data rate). The currently available compression approaches offer a different range of trade-offs, and spawn a plurality of codec profiles, where each profile is optimized to meet the needs of a particular application.

Prior Art FIG. 1 shows an example 100 of trade-offs among the various compression algorithms currently available. As shown, such compression algorithms include wavelet-based codecs 102, and DCT-based codecs 104 that include the various MPEG video distribution profiles.

2D and 3D wavelets are current alternatives to the DCT-based codec algorithms. Wavelets have been highly regarded due to their pleasing image quality and flexible compression ratios, prompting the JPEG committee to adopt a wavelet algorithm for its JPEG2000 still image standard. Unfortunately, most wavelet implementations use very complex algorithms, requiring a great deal of processing power, relative to DCT alternatives. In addition, wavelets present unique challenges for temporal compression, making 3D wavelets particularly difficult.

For these reasons, wavelets have never offered a cost-competitive advantage over high volume industry standard codecs like MPEG, and have therefore only been adopted for niche applications. There is thus a need for a commercially viable implementation of 3D wavelets that is optimized for low power and low cost focusing on three major market segments.

For example, small video cameras are becoming more widespread, and the advantages of handling their signals digitally are obvious. For instance, the fastest-growing segment of the cellular phone market in some countries is for phones with image and video-clip capability. Most digital still cameras have a video-clip feature. In the mobile wireless handset market, transmission of these still pictures and short video clips demand even more capacity from the device battery. Existing video coding standards and digital signal processors put even more strain on the battery.

Another new application is the Personal Video Recorders (PVR) that allow a viewer to pause live TV and time-shift programming. These devices use digital hard disk storage to record the video, and require video compression of analog video from a cable. In order to offer such features as picture-in-picture and watch-while-record, these units require multiple video compression encoders.

Another growing application area is the Digital Video Recorders (DVR) for surveillance and security video. Again, compression encoding is required for each channel of input video to be stored. In order to take advantage of convenient, flexible digital network transmission architectures, the video must be digitized at the camera. Even with the older multiplexing recorder architecture, multiple channel compression encoders are required.

Of course, there are a vast number of other markets which would benefit from a commercially viable implementation of 3D wavelets that is optimized for low power and low cost.

Experience teaches one that images, considered as a function on the 2-dimensional square, are well modeled as a polynomial smooth at most points with some relatively isolated point and line (edge) singularities. A video clip is similarly modeled with a 3-dimensional domain. For most images and video, the RMS (Root Mean Square) residual from a linear polynomial model is in the neighborhood of 5%, and in the neighborhood of 2% for a quadratic polynomial model.

Commonly used schemes for approximating such functions (images and video) comprise the following steps:

1) Reversibly transforming the function so that the transformed coefficients can be divided into “subbands”

2) Quantizing (i.e., reducing the precision of) all but the “low-pass” subband

3) Applying the reverse transformation to the quantized coefficients, thus reconstructing an approximation to the original function.

A good scheme uses a transformation that projects the low degree polynomial content of the function into the unquantized “low pass” subband. Such a scheme will, ideally, also produce zeros or very small values in the other subbands. Subsequent quantization of the non-low-pass subbands will thus not significantly change the transform of a function well-modeled by a sufficiently low degree polynomial, and the approximation of the reconstruction to the original function will be very good.

Implementation realities make it highly desirable for a value in the transformed function to depend only on values in a small neighborhood of some point in the original function domain. This is one of the purposes of the 8×8 blocks in the JPEG and MPEG standards. In these specifications, domain neighborhoods either coincide or do not intersect, partitioning the image domain into a cover of disjoint neighborhoods, each with a distinct border. The approximation resulting from quantization tends to be poor at these borders (the well known “Gibbs effect” in discrete Fourier transforms) resulting in noticeable “blocking” artifacts in the reconstructed, approximated image.

Wavelet transformations have attracted a good deal of attention as a transform class that has the small domain neighborhood property, although with overlapping neighborhoods. Some wavelet transforms do a better job, compared to the DCTs of JPEG/MPEG, of projecting the function primarily into the low-pass subbands. Moreover, some wavelet transforms (not necessarily the same ones) are significantly less compute intensive. However, the domain neighborhood overlap imposes significant implementation problems in the area of data handling, memory utilization, and memory bandwidth. It is still useful to “block” the domain, bringing back their boundaries and the issue of approximation near those boundaries.

Transforms at domain boundaries present a problem in that the domain neighborhood, centered at a boundary point, does not lie within the domain block to which the boundary point belongs. The conventional approach to this problem, as embodied in the various JPEG and MPEG standards, is to reflect symmetrically the domain values in a block across the boundary to create “virtual” values and a virtual function on the required neighborhood.

Unless this virtual function is typically a constant on the neighborhood, it will have a cusp or crease at the boundary resulting from a discontinuous first derivative. This discontinuity is not well modeled by a low degree polynomial and hence is reflected in large non-low-pass subband coefficients that remain large after quantization. The larger quantization error results in an increased approximation error at the boundary.

One of the transforms specified in the JPEG 2000 standard 1) is the reversible 5-3 transform shown in Equations #1.1 and 1.2.

$$\begin{matrix}Equations \#1 .1 and 1.2 & \\ {Y}_{2 n + 1} = {X}_{2 n + 1} - ⌊ \frac{{X}_{2 n} + {X}_{2 n + 2}}{2} ⌋ & eq 1.1 \\ {Y}_{2 n} = {X}_{2 n} + ⌊ \frac{{Y}_{2 n - 1} + {Y}_{2 n + 1} + 2}{4} ⌋ & eq 1.2\end{matrix}$$

As these equations are integer to integer maps and are easily backsolved for the Ys, this transform is reversible and the reverse produces the input Ys exactly bit-for-bit. See Equations #2.1 and 2.2.

$$\begin{matrix}Equations \# 2.1 and 2.2 & \\ {X}_{2 n} = {Y}_{2 n} - ⌊ \frac{{Y}_{2 n - 1} + {Y}_{2 n + 1} + 2}{4} ⌋ & eq 2.1 \\ {X}_{2 n + 1} = {Y}_{2 n + 1} + ⌊ \frac{{X}_{2 n} + {X}_{2 n + 2}}{2} ⌋ & eq 2.2\end{matrix}$$

It is clear from these equations that: Y₂ₙ₊₁ is an estimate of the negative of half of the 2nd derivative at (2n+1); and Y₂ₙ₊₁ is approximately zero if the function is well approximated by a 1st degree polynomial at (2n+1).

The purpose of the constant addition within the floor brackets (└┘) is to remove any DC bias from the estimates. Uncorrected biases in wavelets easily lead to oscillatory errors in the reconstructed data, exhibited as fixed pattern noise such as horizontal or vertical bars. There are several possibilities for bias estimation and correction, of which one has been selected in the JPEG2000 standard.

If the right boundary of the image is at point 2N−1, Equation #1.1 cannot be calculated as the required value X_{2N} is not available. The JPEG 2000 standard requires that this case be addressed by extending the function by positive symmetry so that one uses X_{2N}=X_{2N-2} Making this substitution into Equation #1.1 renders Equation #1.1 ext.

$$\begin{matrix}Equation \#1 .1 ext & \\ {Y}_{2 N - 1} = {X}_{2 N - 1} - ⌊ \frac{{X}_{2 N - 2} + {X}_{2 N - 2}}{2} ⌋ = & eq 1.1 ext \\ = {X}_{2 N - 1} - ⌊ {X}_{2 N - 2} ⌋ = {X}_{2 N - 1} - {X}_{2 N - 2} & \end{matrix}$$

This produces a Y_{2N-1} which is an estimate of the first derivative as opposed to an estimate of half of the negative of the second derivative as in the interior points. Further, it is clear that an estimate of the second derivative can be obtained only by use of three distinct points rather than just two. One needs to confine the two points required in the lifting term to X s with an even index, as these are the only ones available for the reverse step. The closest candidate index is 2N−4.

As can be seen especially in Equations #1.2 and 2.1, the JPEG-2000 formulation of the 5-3 wavelet filters involves addition of a constant 1 or 2 inside the calculation, as well as other limitations. When implemented for maximum speed and efficiency of computation, these additions and other limitations can require a significant fraction of the total computational load, and cause a significant slowdown in performance.

### DISCLOSURE OF THE INVENTION

A system, method and computer program product are provided for compressing data. Initially, an interpolation formula is received. Such interpolation formula is utilized for compressing data. In use, it is determined whether at least one data value is required by the interpolation formula, where the required data value is unavailable. If such is the case, an extrapolation operation is performed to generate the required unavailable data value.

In one embodiment, the interpolation formula may be a component of a wavelet filter. As another option, the wavelet filter may be selectively replaced with a polyphase filter.

In another embodiment, a plurality of the data values may be segmented into a plurality of spans. Thus, an amount of computation involving the interpolation formula may be reduced by only utilizing data values within one of the spans.

In still another embodiment, the data values may be quantized. In such embodiment, an amount of computation associated with entropy coding may be reduced by reducing a quantity of the data values. The quantity of the data values may be reduced during a quantization operation involving the data values.

In still yet another embodiment, an amount of computation associated with reconstructing the data values into a predetermined data range may be reduced. Such computation may be reduced by performing only one single clip operation.

In one embodiment, the wavelet filter includes an interpolation formula including:

$${Y}_{2 n + 1} = ( {X}_{2 n + 1} + 1 / 2 ) - ⌊ \frac{( {X}_{2 n} + 1 / 2 ) + ( {X}_{2 n + 2} + 1 / 2 )}{2} ⌋$$

In one embodiment, the wavelet filter includes an interpolation formula including:

Y_{2N+1}=(X_{2N+1}+½)−(X_{2N}+½)

In one embodiment, the wavelet filter includes an interpolation formula including:

$$( {Y}_{2 n} + 1 / 2 ) = ( {X}_{2 n} + 1 / 2 ) + ⌊ \frac{{Y}_{2 n - 1} + {Y}_{2 n + 1}}{4} ⌋$$

In one embodiment, the wavelet filter includes an interpolation formula including:

$$( {Y}_{0} + 1 / 2 ) = ( {X}_{0} + 1 / 2 ) + ⌊ \frac{{Y}_{1}}{2} ⌋$$

In one embodiment, the wavelet filter includes an interpolation formula including:

$$( {X}_{2 n} + 1 / 2 ) = ( {Y}_{2 n} + 1 / 2 ) - ⌊ \frac{{Y}_{2 n - 1} + {Y}_{2 n + 1}}{4} ⌋$$

In one embodiment, the wavelet filter includes an interpolation formula including:

$$( {X}_{0} + 1 / 2 ) = ( {Y}_{0} + 1 / 2 ) - ⌊ \frac{{Y}_{1}}{2} ⌋$$

In one embodiment, the wavelet filter includes an interpolation formula including:

$$( {X}_{2 n + 1} + 1 / 2 ) = {Y}_{2 n + 1} + ⌊ \frac{( {X}_{2 n} + 1 / 2 ) + ( {X}_{2 n + 2} + 1 / 2 )}{2} ⌋$$

In one embodiment, the wavelet filter includes an interpolation formula including:

(X_{2N+1}+½)=Y_{2N+1}+(X_{2N +}+½)

### BRIEF DESCRIPTION OF THE DRAWINGS

Prior Art FIG. 1 shows an example of trade-offs among the various compression algorithms currently available.

FIG. 2 illustrates a framework for compressing/decompressing data, in accordance with one embodiment.

FIG. 3 illustrates a method for compressing/decompressing data, in accordance with one embodiment.

FIG. 4 shows a data structure on which the method of FIG. 3 is carried out.

FIG. 5 illustrates a method for compressing/decompressing data, in accordance with one embodiment.

### DESCRIPTION OF THE PREFERRED EMBODIMENTS

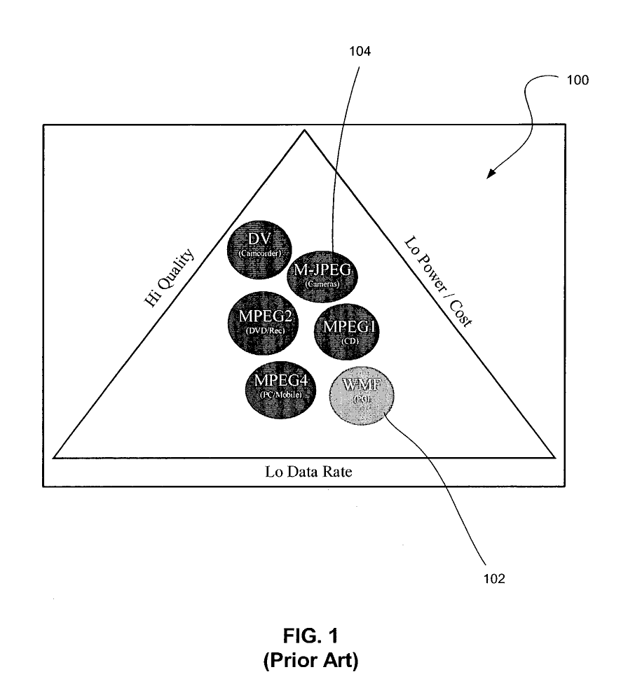

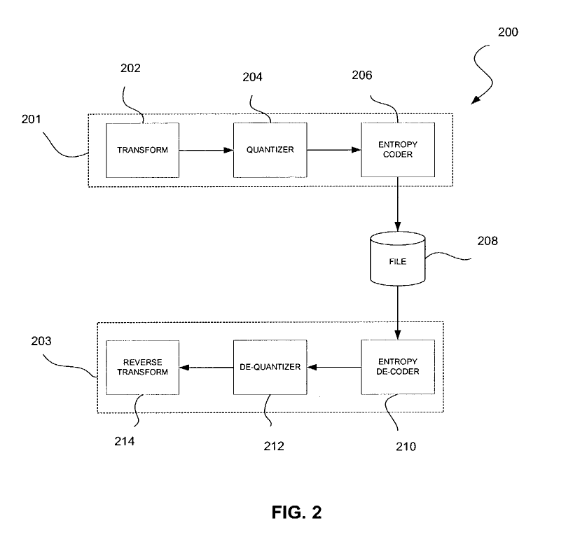

FIG. 2 illustrates a framework 200 for compressing/decompressing data, in accordance with one embodiment. Included in this framework 200 are a coder portion 201 and a decoder portion 203, which together form a “codec.” The coder portion 201 includes a transform module 202, a quantizer 204, and an entropy encoder 206 for compressing data for storage in a file 208. To carry out decompression of such file 208, the decoder portion 203 includes a reverse transform module 214, a de-quantizer 212, and an entropy decoder 210 for decompressing data for use (i.e. viewing in the case of video data, etc).

In use, the transform module 202 carries out a reversible transform, often linear, of a plurality of pixels (in the case of video data) for the purpose of de-correlation. Next, the quantizer 204 effects the quantization of the transform values, after which the entropy encoder 206 is responsible for entropy coding of the quantized transform coefficients.

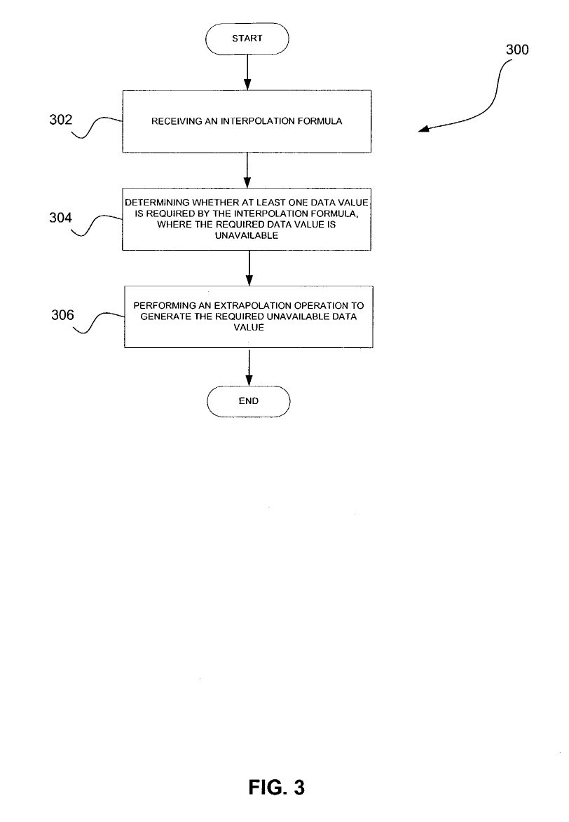

FIG. 3 illustrates a method 300 for compressing/decompressing data, in accordance with one embodiment. In one embodiment, the present method 300 may be carried out in the context of the transform module 202 of FIG. 2 and the manner in which it carries out a reversible transform. It should be noted, however, that the method 300 may be implemented in any desired context.

In operation 302, an interpolation formula is received (i.e. identified, retrieved from memory, etc.) for compressing data. In the context of the present description, the data may refer to any data capable of being compressed. Moreover, the interpolation formula may include any formula employing interpolation (i.e. a wavelet filter, etc.).

In operation 304, it is determined whether at least one data value is required by the interpolation formula, where the required data value is unavailable. Such data value may include any subset of the aforementioned data. By being unavailable, the required data value may be non-existent, out of range, etc.

Thereafter, an extrapolation operation is performed to generate the required unavailable data value. See operation 306. The extrapolation formula may include any formula employing extrapolation. By this scheme, the compression of the data is enhanced.

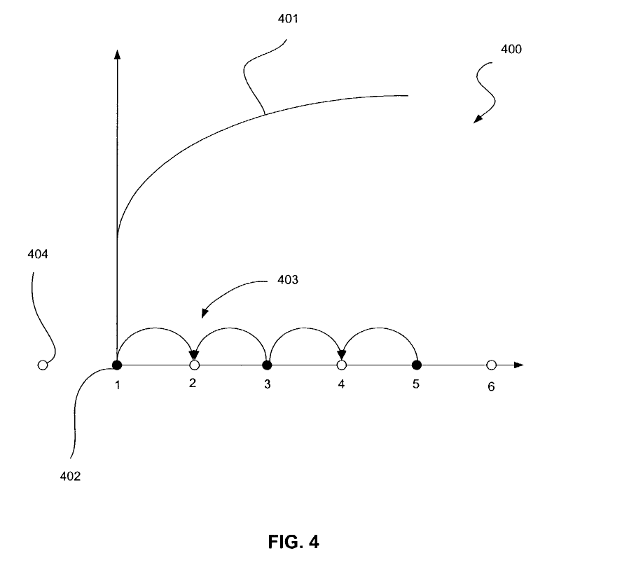

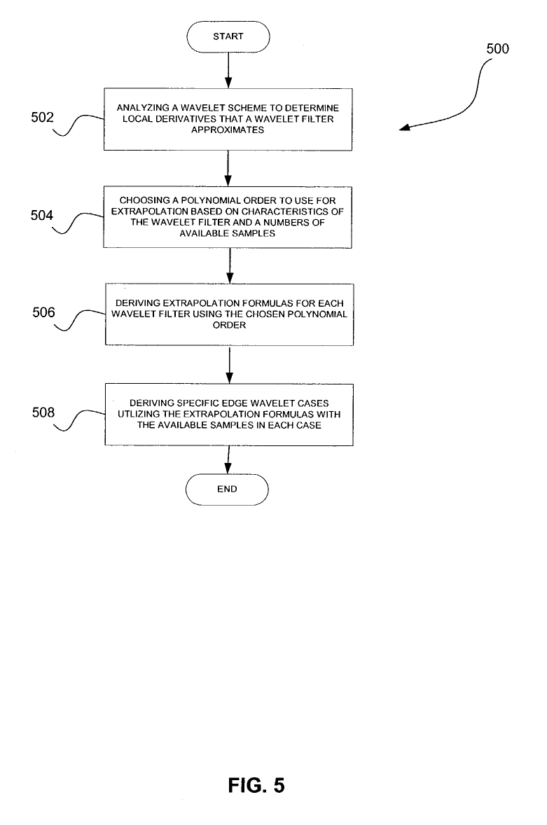

FIG. 4 shows a data structure 400 on which the method 300 is carried out. As shown, during the transformation, a “best fit” 401 may be achieved by an interpolation formula 403 involving a plurality of data values 402. Note operation 302 of the method 300 of FIG. 3. If it is determined that one of the data values 402 is unavailable (see 404 ), an extrapolation formula may be used to generate such unavailable data value. More optional details regarding one exemplary implementation of the foregoing technique will be set forth in greater detail during reference to FIG. 5.

FIG. 5 illustrates a method 500 for compressing/decompressing data, in accordance with one embodiment. As an option, the present method 500 may be carried out in the context of the transform module 202 of FIG. 2 and the manner in which it carries out a reversible transform. It should be noted, however, that the method 500 may be implemented in any desired context.

The method 500 provides a technique for generating edge filters for a wavelet filter pair. Initially, in operation 502, a wavelet scheme is analyzed to determine local derivatives that a wavelet filter approximates. Next, in operation 504, a polynomial order is chosen to use for extrapolation based on characteristics of the wavelet filter and a numbers of available samples. Next, extrapolation formulas are derived for each wavelet filter using the chosen polynomial order. See operation 506. Still yet, in operation 508, specific edge wavelet cases are derived utilizing the extrapolation formulas with the available samples in each case.

See Appendix A for an optional method of using Vandermonde type matrices to solve for the coefficients. Moreover, additional optional information regarding exemplary extrapolation formulas and related information will now be set forth in greater detail.

To approximate Y_{2N-1} from the left, one may fit a quadratic polynomial from the left. Approximating the negative of half the 2nd derivative at 2N−1 using the available values yields Equation #1.1.R. See Appendix A for one possible determination of this extrapolating quadratic.

$$\begin{matrix}Equation \# 1.1 . R & \\ {Y}_{2 N - 1} = - \frac{1}{3} ( {X}_{2 N - 1} - ⌊ \frac{3 {X}_{2 N - 2} - {X}_{2 N - 4} + 1}{2} ⌋ ) & eq 1.1 . R\end{matrix}$$

Equation #1.1.R may be used in place of Equation #1.1 (see background section) when point one is right-most. The apparent multiply by 3 can be accomplished with a shift and add. The division by 3 is trickier. For this case where the right-most index is 2N−1, there is no problem calculating Y_{2N-2} by means of Equation #1.2 (again, see background section). In the case where the index of the right-most point is even (say 2N ), there is no problem with Equation #1.1, but Equation #1.2 involves missing values. Here the object is to subtract an estimate of Y from the even X using just the previously calculated odd indexed Y s, Y₁ and Y₃ in the case in point. This required estimate at index 2N can be obtained by linear extrapolation, as noted above. The appropriate formula is given by Equation #1.2.R.

$$Equation \#1 .2 . R \\ {Y}_{2 N} = {X}_{2 N} + ⌊ \frac{3 {Y}_{2 N - 1} - {Y}_{2 N - 3} + 2}{4} ⌋ \qquad eq 1.2 . R$$

A corresponding situation applies at the left boundary. Similar edge filters apply with the required extrapolations from the right (interior) rather than from the left. In this case, the appropriate filters are represented by Equations #1.1.L and 1.2.L.

$$\begin{matrix}Equations \#1 .1 . L and 1.2 . L \\ {Y}_{0} = - \frac{1}{3} ( {X}_{0} - ⌊ \frac{3 {X}_{1} - {X}_{3} + 1}{2} ⌋ ) & eq 1.1 . L \\ {Y}_{0} = {X}_{0} + ⌊ \frac{3 {Y}_{1} - {Y}_{3} + 2}{4} ⌋ & e q 1.2 . L\end{matrix}$$

The reverse transform filters can be obtained for these extrapolating boundary filters as for the original ones, namely by back substitution. The inverse transform boundary filters may be used in place of the standard filters in exactly the same circumstances as the forward boundary filters are used. Such filters are represented by Equations #2.1.Rinv, 2.2.Rinv, 2.1.L.inv, and 2.2.L.inv.

$$\begin{matrix}Equations \#2 .1 . R inv , 2.2 . Rinv , 2.1 . L . inv , 2.2 . L . inv \\ {X}_{2 N - 1} = - 3 {Y}_{2 N - 1} + ⌊ \frac{3 {X}_{2 N - 2} - {X}_{2 N - 4} + 1}{2} ⌋ & eq 2.1 . R inv \\ {X}_{2 N} = {Y}_{2 N} - ⌊ \frac{3 {Y}_{2 N - 1} - {Y}_{2 N - 3} + 2}{4} ⌋ & e q 2.2 . R i n v \\ {X}_{0} = - 3 {Y}_{0} + ⌊ \frac{3 {X}_{1} - {X}_{3} + 1}{2} ⌋ & e q 2.1 . L in v \\ {X}_{0} = {Y}_{0} - ⌊ \frac{3 {Y}_{1} - {Y}_{3} + 2}{4} ⌋ & e q 2.2 . L i n v\end{matrix}$$

Thus, one embodiment may utilize a reformulation of the 5-3 filters that avoids the addition steps of the prior art while preserving the visual properties of the filter. See for example, Equations #3.1, 3.1R, 3.2, 3.2L.

$$\begin{matrix}Equations \#3 .1 , 3.1 R , 3.2 , 3.2 L \\ {Y}_{2 n + 1} = ( {X}_{2 n + 1} + 1 / 2 ) - ⌊ \frac{( {X}_{2 n} + 1 / 2 ) + ( {X}_{2 n + 2} + 1 / 2 )}{2} ⌋ & eq 3.1 \\ {Y}_{2 N + 1} = ( {X}_{2 N + 1} + 1 / 2 ) - ( {X}_{2 N} + 1 / 2 ) & e q 3.1 R \\ ( {Y}_{2 n} + 1 / 2 ) = ( {X}_{2 n} + 1 / 2 ) + ⌊ \frac{{Y}_{2 n - 1} + {Y}_{2 n + 1}}{4} ⌋ & e q 3.2 \\ ( {Y}_{0} + 1 / 2 ) = ( {X}_{0} + 1 / 2 ) + ⌊ \frac{{Y}_{1}}{2} ⌋ & e q 3.2 L\end{matrix}$$

In such formulation, certain coefficients are computed with an offset or bias of ½, in order to avoid the additions mentioned above. It is to be noted that, although there appear to be many additions of ½ in this formulation, these additions need not actually occur in the computation. In Equations #3.1 and 3.1R, it can be seen that the effects of the additions of ½ cancel out, so they need not be applied to the input data. Instead, the terms in parentheses (Y₀+½) and the like may be understood as names for the quantities actually calculated and stored as coefficients, passed to the following level of the wavelet transform pyramid.

Just as in the forward case, the JPEG-2000 inverse filters can be reformulated in the following Equations #4.2, 4.2L, 4.1, 4.1R.

$$\begin{matrix}Equations \#4 .2 , 4.2 L , 4.1 , 4.1 R \\ ( {X}_{2 n} + 1 / 2 ) = ( {Y}_{2 n} + 1 / 2 ) - ⌊ \frac{{Y}_{2 n - 1} + {Y}_{2 n + 1}}{4} ⌋ & eq 4.2 \\ ( {X}_{0} + 1 / 2 ) = ( {Y}_{0} + 1 / 2 ) - ⌊ \frac{{Y}_{1}}{2} ⌋ & eq 4.2 L \\ ( {X}_{2 n + 1} + 1 / 2 ) = {Y}_{2 n + 1} + ⌊ \frac{( {X}_{2 n} + 1 / 2 ) + ( {X}_{2 n + 2} + 1 / 2 )}{2} ⌋ & eq 4.1 \\ ( {X}_{2 N + 1} + 1 / 2 ) = {Y}_{2 N + 1} + ( {X}_{2 N} + 1 / 2 ) & eq 4.1 R\end{matrix}$$

As can be seen here, the values taken as input to the inverse computation are the same terms produced by the forward computation in Equations #3.1˜3.2L and the corrections by ½ need never be calculated explicitly.

In this way, the total number of arithmetic operations performed during the computation of the wavelet transform is reduced.

Optional Features

Additional optional features and techniques that may be used in the context of the systems and methods of FIGS. 2-5 will now be set forth. It should be noted such optional features are set forth strictly for illustrative purposes and should not be construed as limiting in any manner. Moreover, such features may be implemented independent from the foregoing systems and methods of FIGS. 2-5.

General Optional Features

In use, a transform module (i.e. see, for example, transform module 202 of FIG. 2, etc.) may utilize a wavelet pyramid that acts as a filter bank separating the image into sub-bands each covering approximately one octave (i.e. factor of 2). At each octave, there may be three sub-bands corresponding to horizontal, vertical, and checkerboard features. In one embodiment, the pyramids may be typically three to five levels deep, covering the same number of octaves. If the original image is at all smooth, the magnitude of the wavelet coefficients decreases rapidly. Images may have a Holder coefficient of ⅔ meaning roughly that the image has ⅔ of a derivative. If the wavelet coefficients are arranged in descending order of absolute value, those absolute values may be seen to decrease as N^{-s} where N is the position in the sequence and s is the smoothness of the image.

After forming the wavelet pyramid, the wavelet coefficients may be scaled (quantized) by a quantizer (i.e. see, for example, quantizer 204 of FIG. 2, etc.) to render a result that is consistent with the viewing conditions and the human visual contrast sensitivity curve (CSF). By accounting for the characteristics of the human visual system (HVS), the number of bits used to code the chroma subbands may be reduced significantly.

To provide a fast algorithm implementable in minimal silicon area demands, the use of a traditional arithmetic coder may be avoided. For example, multiplies may be avoided as they are very expensive in silicon area, as set forth earlier. Moreover, such algorithm may have a very good “fast path” for the individual elements of the runs.

The codec may employ a group of pictures (GOP) of two interlaced video frames, edge filters for the boundaries, intermediate field image compression and block compression structure. Specific features of the implementation for a small single chip may be as follows in Table 1.

TABLE 1

One implementation may use short wavelet bases
(the 2-6 wavelet), which are particularly
appropriate for those that focus on natural scene
images quantized to match the HVS. Implementation
can be accomplished with adds and shifts. A
Mallat pyramid may be used resulting from five
filter applications in the horizontal direction
and three applications in the vertical direction
for each field. This produces filters with dyadic
coefficients, two coefficients in the low pass
filter and two, four, or six coefficients in the
wavelet filters (resulting in twelve wavelet sub-
bands). One may use modified edge filters near
block and image boundaries so as to utilize actual
image values. The resulting video pyramids may
have substantial runs of zeros and also
substantial runs of non-zeros. Encoding can
therefore be done efficiently by table look-up.
Another solution may use motion image compression
via 3D wavelet pyramid in place of the motion
compensation search used in MPEG-like methods. One
may apply transform compression in the temporal
direction to a GOP of four fields. A two level
temporal Mallat pyramid may be used as a tensor
product with the spatial pyramid. The linear edge
filters may be used at the fine level and the
modified Haar filters at the coarse level,
resulting in four temporal subbands. Each of
these temporal subbands is compressed.
Processing can be decoupled into the processing of
blocks of 8 scan lines of 32 pixels each. This
helps reduce the RAM requirements to the point
that the RAM can be placed in the ASIC itself.
This reduces the chip count and simplifies the
satisfaction of RAM bandwidth requirements.
Compression processing may be performed stripe by
stripe (two passes per stripe) . A “stripe” is 8
pixels high and the full width of the picture.
Still another embodiment can use quantization of
the wavelet coefficients to achieve further
improvement in compression. Quantization
denominators are powers of two, enabling
implementation by shifts. Quantization may refer
to a process of assigning scaling factors to each
subband, multiplying each coefficient in a sub
band by the corresponding scaling factor, and
fixing the scaled coefficient to an integer.

Combined Filters

As another option, the wavelet filters may be selectively replaced with polyphase filters. In one embodiment, such replacement may occur in a transform module (i.e. see transform module 202 and/or reverse transform module 214 of FIG. 2) of a data compression/decompression system. Of course, such feature may be implemented independent of the various other features described herein. More exemplary information regarding the present optional feature will now be set forth.

In the present embodiment, the use of conventional [i.e. Finite Impulse Response (FIR)] information-discarding or smoothing filters may be combined with wavelet information-preserving filters in the design of a video compression codec. FIR filters may be distinguished from wavelet filters in that the conventional FIR filters are used singly, whereas wavelet filters always come as a complementary pair. Also, the FIR filters in a wavelet transform are not necessarily related to each other as a polyphase filter bank.

Video compression may be performed in a three-step process; sometimes other steps are added, but the three main phases are these: transformation, quantization, and entry coding, as set forth earlier. These operations, as usually practiced, typically only discard information during quantization. In fact, a lossless compression method may result if this operation is omitted. However, lossless compression is limited to much smaller compression ratios than lossy compression which takes advantage of the human visual system and discards information which makes no visual difference, or negligible visual difference, in the decoded result.

One class of visual information that can sometimes be lost with acceptable results is fine detail. While most transform processes used in video compression are capable of discarding fine detail information through the quantization step, they may do so less efficiently or with less visual fidelity than a direct low-pass filter implementation.

One way to implement a smoothing filter is by use of a FIR structure. An alternative way to implement a smoothing filter is by use of an Infinite Impulse Response (IIR) structure.

When the size of an image or a data sequence is to be changed, a Polyphase Filter Bank (PFB) composed of related FIR filters may be employed. Such method processes the image by removing some detail and producing a correspondingly smaller image for further processing.

A polyphase filter bank may include a set of FIR filters that share the same bandwidth, or frequency selectivity properties, but generate pixels interpolated at different locations on or between the original samples.

For example, a polyphase filter bank can be used to reduce an image (i.e. a frame of video) to ⅔ of its original width. It does this by computing interpolated pixels midway between each of the original pixels, computing smoothed pixels at the original locations, then keeping only every third pixel of the resulting stream.

With this method, it may be possible to omit computing the pixels that will not be kept, resulting in a more efficient method of reducing the image size. This process generalizes easily to other rational fractional size changes. In this way, a polyphase filter bank can smoothly remove a small amount of fine detail, scaling an image by a factor less than one (1). The factor can be greater than ½.

The present embodiment combines the benefits of smooth detail removal with the picture quality of wavelet transform coding by using a polyphase filter as the first stage of a wavelet based image compression process. By using this combination, one may add the advantage of smooth, high-quality, artifact-free removal of the finest details and the bits that would be required to represent them, from using a polyphase filter bank, to the well-known advantages of fast efficient computation and high visual quality from using a wavelet transform as the basis for image and video compression.

In a first embodiment of the present method, one may first apply a polyphase filter bank to the image in one direction, typically the horizontal direction, and then apply a wavelet transform to the image before quantizing and entropy coding in the conventional way.

In a second embodiment of the present method, one may apply a polyphase filter in a particular direction before the first wavelet operation in that direction, but possibly after wavelet operations in other directions.

In still another embodiment, one may apply a polyphase filter in each of several directions, before the first wavelet operation for that direction but possibly after wavelet steps in other directions.

There are several advantages to the present method of applying a lossy filtering step before at least some wavelet or DCT transform stages. For instance, filters such as FIR or polyphase designs, not being constrained to function in a wavelet fashion, may be designed for higher quality and smaller artifacts. Wavelet filters may be designed in pairs that split the information into two parts without discarding information.

Applying a lossy filter before transform operations, rather than after, means that the transform computation may operate on less data and hence take less time to compute and take less intermediate storage while computing. Because the transform is typically an expensive part of the compression process, this reduction results in a significantly improved speed and efficiency for the overall compression process.

Sparse Wavelet Transform Using Piles

As yet another option, an amount of computation associated with entropy coding may be reduced by reducing a quantity of the data values. In one embodiment, such reduction may occur in a quantizer (i.e. see quantizer 204 of FIG. 2) of a data compression/decompression system. Of course, such feature may be implemented independent of the various other features described herein. More exemplary information regarding the present optional feature will now be set forth.

In the present embodiment, piles may be used as an operation in the decoding operation and are thus ready for use in computing the succeeding steps. See Appendix B for more information regarding piles.

It is well known in the field of scientific computing to provide what are called sparse representations for matrix data. Ordinary matrices are represented as the complete array of numbers that are the matrix elements; this is called a “dense” representation. Some program packages store, convert, and operate on “sparse matrices” in which the zero entries are not represented explicitly one-by-one, but are implicitly represented. One such “sparse” representation is zero-run coding, in which zeros are represented by the count of zeros occurring together. This count can itself be zero (when two nonzero values are adjacent), one (for an isolated zero value), or larger.

However, if video data are not matrices, one does not typically apply matrix operations (i.e. multiplication, inverse, eigenvalue decomposition, etc) to them. The principles underlying sparse matrix computation can be extracted and translated to video transforms.

Briefly, a pile consists of an array of pairs; each pair gives the address (or offset) in the ordinary data of a nonzero item together with the value of that item. The addresses or offsets are in sorted order, so that one can traverse the entire data set from one end to the other by traversing the pile and operating on the nonzero elements in it, taking account of their place in the full data set.

Piles are specifically designed to be efficiently implementable on computers that process data in parallel using identical operations on several data items at once (i.e. SIMD processors), and on computers that make conditional transfers of control relatively expensive. These processors are in common use to handle video and audio, and are sometimes called “media processors”.

When one needs to perform some operation on two data sets, both of which are sparse, there arises a consideration not present when the data are represented densely. That is, “when do the data items coincide with each other?”

In operating on two data sets represented as piles, the basic operation for identifying coincident data items is called “match and merge”. As one traverses the two piles, he or she may have at every operation after the beginning an address from each pile and an address for which an output value has been just produced. In order to find the next address for which one can produce a value, the minimum of the two addresses presented by the input piles may be found. If both piles agree on this address, there is a data item available from each and one can operate on the two values to produce the desired result. Then, one may step to the next item on both piles.

If the next addresses in the two piles differ, a nonzero value is present in one pile (one data set) but a zero value in the other data set (implicitly represented by the pile); one may operate on the one value and zero, producing a value. Alternatively, if the operation one is performing produces zero when one input is zero, no value is produced. In either case, one may step to the next item only on the pile with the minimum address.

The result values are placed in an output location, either a dense array (by writing explicit zeros whenever the address is advanced by more than one) or in an output pile.

As mentioned earlier, a wavelet transform comprises the repeated application of wavelet filter pairs to a set of data, either in one dimension or in more than one. For video compression, one may use a 2-D wavelet transform (horizontal and vertical) or a 3-D wavelet transform (horizontal, vertical, and temporal).

The intent of the transform stage in a video compressor is to gather the energy or information of the source picture into as compact a form as possible by taking advantage of local similarities and patterns in the picture or sequence. No compressor can possibly compress all possible inputs; one may design compressors to work well on “typical” inputs and ignore their failure to compress “random” or “pathological” inputs.

When the transform works well, and the picture information is well gathered into a few of the transform coefficients, the remaining coefficients have many zeros among them.

It is also a stage of video compressors to quantize the results, as set forth earlier. In this stage, computed values that are near zero are represented by zeros. It is sometimes desirable to quantize computed coefficients during the computation of the wavelet transform, rather than or in addition to quantizing the final transformed result.

So one can get many zeros in some of the wavelet coefficient data, and this can happen while there is a need to do more computing on the data.

Additionally, when one is decoding a compressed image or video to display it, he or she may work from the entropy-coded significant coefficients back toward a completely filled-in image for display. The typical output of the first decoding step, entropy-code decoding, is a set of significant coefficients with large numbers of non-significant coefficients, considered by default to be zero, among them.

When this happens, it is valuable to convert the dense data with many zeros into a sparse representation; one may do this by piling the data as disclosed earlier. The pile representations resemble run-of-zero representations but usually store an address or offset, rather than the run length (a difference of addresses). This allows faster processing both to create the pile and to expand the pile into a dense representation later.

In the case of decoding, the data are not in a dense form and it is more natural to construct the piles directly in the entropy decoder.

The processing of wavelet transforms presents several cases that are susceptible to piling treatment. Note Table 2 below:

TABLE 2

decompressing, both bands piled
decompressing, one band piled
decompressing, input piled and output dense
compressing, input dense and output piled

One example will be considered: decoding a compressed frame of video, where the encoding process has resulted in very many of the coefficients being quantized to zero. The first stages of decompression undo the entropy-encoding or bit-encoding of the nonzero coefficients, giving the values and the location of each value in the frame. This is just the information represented in a pile, and it is very convenient to use a pile to store it, rather than expanding it immediately to a dense representation by explicitly filling in all the intervening zero values.

At this stage, one has the coefficients ready to be operated upon by the inverse wavelet transform. The final result of the inverse transform is the decompressed image ready to be displayed; it is only rarely sparse.

The first stage of the inverse wavelet transform (like each stage) is a filter computation that takes data from two areas or “bands” of the coefficient data and combines them into an intermediate band, which will be used in further stages of the same process. At this first stage, the data for both bands is sparse and represented in piles. One may produce the output of this stage in a pile, too, so that he or she need not fill in zeros. The computation below in Table 3 operates on “band” piles P₁ and P₂, produces its result in new pile R, and performs the filter computation step W(p, q) on pairs of coefficients from the two bands.

TABLE 3

| | |
|---|---|
| while not both EOF(P₁), EOF(P₂) | { |
| I₁=0; I₂=0; | |
| guard(P₁.index ≦ P₂.index, Pile_Read(P₁, I₁)); | |
| guard(P₁.index ≧ P₂.index, Pile_Read(P₂, I₂)); | |
| Conditional_Append(R, true, W(I₁, I₂)); | }; |
| Destroy_Pile (P₁); Destroy_Pile (P₂); | |

It should be noted that the foregoing computation can still be unrolled for parallel operation, as shown in Appendix B.

The time taken to compute the wavelet transform may be reduced by using a sparse representation, piles, for intermediate results that have many zero values. Such method improves the performance and computational efficiency of wavelet-based image compression and video compression products.

Transform Range Limit

As yet another option, an amount of computation associated with reconstructing the data values into a predetermined data range may be reduced. Such computation may be reduced by performing only one single clip operation. In one embodiment, such reduction may occur in a de-quantizer module (i.e. see de-quantizer 212 of FIG. 2) of a data compression/decompression system. Of course, such feature may be implemented independent of the various other features described herein. More exemplary information regarding the present optional feature will now be set forth.

In digital image compression and digital video compression methods, images (or frames) are represented as arrays of numbers, each number representing the brightness of an area or the quantity of a particular color (such as red) in an area. These areas are called pixels, and the numbers are called samples or component values.

Image compression or video compression is done using a wide range of different methods. As mentioned earlier, many of these methods involve, as a step, the computation of a transform: through a sequence of arithmetic operations, the array of samples representing an image is transformed into a different array of numbers, called coefficients, that contain the image information but do not individually correspond to brightness or color of small areas. Although the transform contains the same image information, this information is distributed among the numbers in a way that is advantageous for the further operation of the compression method.

When an image or frame, compressed by such a method, is to be replayed, the compressed data must be decompressed. Usually this involves, as a step, computing an inverse transform that takes an array of coefficients and produces an array of samples.

The samples of an image or frame are commonly represented by integers of small size, typically 8 binary bits. Such an 8 bit number can represent only 256 distinct values, and in these applications the values are typically considered to be the range of integers [0, 255] from zero through 255 inclusive.

Many standards and operating conditions impose more restricted ranges than this. For example, the pixel component (Y, U, V) sample values in CCIR-601 (ITU-R BT.601−4) digital video are specified to lie within smaller ranges than [0, 255]. In particular, the luma Y component valid range in the lit part of the screen is specified to lie within [16, 235], and the chroma U, V range is specified to line within [16, 240]. Values outside these ranges can have meanings other than brightness, such as indicating sync events.

Image and video compression methods can be divided into two categories, lossless and lossy. Lossless compression methods operate in such a way as to produce the exact same values from decompression as were presented for compression. For these methods there is no issue of range, since the output occupies the same range of numbers as the input.

Lossy compression, however, produces a decompressed output that is only expected to approximate the original input, not to match it bit for bit. By taking advantage of this freedom to alter the image slightly, lossy methods can produce much greater compression ratios.

In the decompression part of a lossy compression method, the samples computed are not guaranteed to be the same as the corresponding original sample and thus are not guaranteed to occupy the same range of values. In order to meet the range conditions of the image standards, therefore, there must be included a step of limiting or clipping the computed values to the specified range.

The straightforward way to perform this clipping step is as follows: For every computed sample s, test whether s>max and if so set s=max; test whether s<min and if so set s=min.

Another way to perform this step uses the MAX and MIN operators found in some computing platforms; again, on may apply two operations to each sample. Both the ways shown, and many others, are more computationally expensive than a simple arithmetic operation such as an add or subtract.

Since this process may be performed separately for every sample value (every pixel) in the image or frame, it is a significant part of the computation in a decompression method. Note that for nearly all of the computed samples, which normally lie well within the required range, both tests will fail and thus both tests must be computed.

Transform computations as described above commonly have the following property: one of the resulting coefficients represents the overall brightness level the entire frame, or a significant part of the frame (a block, in MPEG terminology). This coefficient is called a “DC coefficient.” Because of the way the transform is computed, altering the DC coefficient alters the value of all the samples in its frame or block in the same way, proportionally to the alteration made. So it is possible, for example, to increase the value of every sample in a block by the same amount, by adding a properly chosen constant to the DC coefficient for the block just before computing the inverse transform.

The computing engines upon which compression methods are executed commonly have arithmetic instructions with the saturation property: when a result is calculated, if it would exceed the representation range of its container (for 8-bit quantities, [0, 255]), the result is clipped to lie within that range. For example, if a saturating subtract instruction is given the values 4 and 9, the result instead of (4−9=)−5 would be clipped, and the result 0 would be returned. Likewise a saturating add instruction would deliver for 250+10 the result 255.

A lower-cost way to clip the pixel component values will now be described that results from decoding to appropriate limits, in many compression methods. The present embodiment performs one of the two clips with saturating arithmetic, by carrying a bias on the part values, leaving only one of the MAX/MIN ops. To see an example in more detail, when the range required is [llim, ulim]=[16, 240], see Table 4.

TABLE 4

| | |
|---|---|
| 1. | Apply a bias to the DC coefficient in each block which |
| | will result, after all the transform filters, in each |
| | part being offset by negative 16 (−llim in general) |
| | Cost: one arithmetic operation per block or image. |
| 2. | Be sure that the final arithmetic step of the inverse |
| | transform saturates (clips) at zero. |
| | Cost: free on most compute engines. |
| 3. | Apply the MAX operation, partitioned, with 224 (ulim |
| | llim in general) |
| | Cost: one MAX operation per sample. |
| 4. | Remove bias using ADD 16 (llim in general). This cannot |
| | overflow because of the MAX just before; it does not |
| | need to be done with saturating arithmetic. |
| | Cost: one ADD per sample. |

As is now apparent, the computational cost of the necessary range limiting can be reduced from two MAX/MIN operations per sample to one ADD per block, one MAX per sample, and one simple ADD per sample.

On some computing engines, for example the EQUATOR MAP-CA processor, the savings of using the present method can be much more substantial than is readily apparent from the foregoing. On these engines, several samples can be combined in a word and operated upon simultaneously. However, these partitioned operations are limited to certain parts of the processor, and in compression applications can be the limiting resource for performance. On such an engine, the fact that the ADD in Step 4 above cannot overflow is highly significant. Step 4 need not use the special partitioned ADD, but can use an ordinary ADD to operate on several samples at once as if partitioned. This ordinary operation uses a part of the processor that is not as highly loaded and can be overlapped, or executed at the same time as other necessary partitioned operations, resulting in a significant saving of time in computing the inverse transform.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for compressing data, comprising:
receiving an interpolation formula;
determining whether at least one data value is required by the interpolation formula, where the required data value is unavailable; and
performing an extrapolation operation to generate the required unavailable data value;
wherein the interpolation formula is utilized for compressing data.

2. The method as recited in claim 1, wherein the interpolation formula is a component of a wavelet filter.

3. The method as recited in claim 1, and further comprising segmenting a plurality of the data values into a plurality of spans.

4. The method as recited in claim 3, and further comprising reducing an amount of computation involving the interpolation formula by only utilizing data values within one of the spans.

5. The method as recited in claim 2, and further comprising selectively replacing the wavelet filter with a polyphase filter.

6. The method as recited in claim 1, and further comprising quantizing the data values.

7. The method as recited in claim 6, and further comprising reducing an amount of computation associated with entropy coding by reducing a quantity of the data values.

8. The method as recited in claim 7, wherein the quantity of the data values is reduced during a quantization operation involving the data values.

9. The method as recited in claim 7, wherein the quantity of the data values is reduced using piles.

10. The method as recited in claim 1, and further comprising reducing an amount of computation associated with reconstructing a plurality of the data values into a predetermined data range.

11. The method as recited in claim 10, wherein the computation is reduced by performing only one single clip operation.

12. The method as recited in claim 2, wherein the wavelet filter includes an interpolation formula including:
$${Y}_{2 n + 1} = ( {X}_{2 n + 1} + 1 / 2 ) - ⌊ \frac{( {X}_{2 n} + 1 / 2 ) + ( {X}_{2 n + 2} + 1 / 2 )}{2} ⌋$$

13. The method as recited in claim 2, wherein the wavelet filter includes an interpolation formula including:
Y_{2N+1}=(X_{2N+1}+½)−(X_{2N}+½)

14. The method as recited in claim 2, wherein the wavelet filter includes an interpolation formula including:
$$( {Y}_{2 n} + 1 / 2 ) = ( {X}_{2 n} + 1 / 2 ) + ⌊ \frac{{Y}_{2 n - 1} + {Y}_{2 n + 1}}{4} ⌋$$

15. The method as recited in claim 2, wherein the wavelet filter includes an interpolation formula including:
$$( {Y}_{0} + 1 / 2 ) = ( {X}_{0} + 1 / 2 ) + ⌊ \frac{{Y}_{1}}{2} ⌋$$

16. The method as recited in claim 2, wherein the wavelet filter includes an interpolation formula including:
$$( {X}_{2 n} + 1 / 2 ) = ( {Y}_{2 n} + 1 / 2 ) - ⌊ \frac{{Y}_{2 n - 1} + {Y}_{2 n + 1}}{4} ⌋$$

17. The method as recited in claim 2, wherein the wavelet filter includes an interpolation formula including:
$$( {X}_{0} + 1 / 2 ) = ( {Y}_{0} + 1 / 2 ) - ⌊ \frac{{Y}_{1}}{2} ⌋$$

18. The method as recited in claim 2, wherein the wavelet filter includes an interpolation formula including:
$$( {X}_{2 n + 1} + 1 \text{/} 2 ) = {Y}_{2 n + 1} + ⌊ \frac{( {X}_{2 n} + 1 \text{/} 2 ) + ( {X}_{2 n + 2} + 1 / 2 )}{2} ⌋$$

19. The method as recited in claim 2, wherein the wavelet filter includes an interpolation formula including:
(X_{2N+1}+½)=Y_{2N+2}+(X_{2N}+½)

20. A computer program product for compressing data, comprising:
computer code for receiving an interpolation formula;
computer code for determining whether at least one data value is required by the interpolation formula, where the required data value is unavailable; and
computer code for performing an extrapolation operation to generate the required unavailable data value;
wherein the interpolation formula is utilized for compressing data.

21. A system for compressing data, comprising:
logic for:
analyzing a wavelet scheme to determine local derivatives that a wavelet filter approximates;
choosing a polynomial order to use for extrapolation based on characteristics of the wavelet filter and a numbers of available samples;
deriving extrapolation formulas for each wavelet filter using the chosen polynomial order; and
deriving specific edge wavelet cases utilizing the extrapolation formulas with the available samples in each case.
